(19) United States
(12) Patent Application Publication
(10) Pub. No.: US 2013/0029818 A1
(43) Pub. Date: Jan. 31, 2013

(54) SLEEVED ROLLER FOR USE IN AN ELECTROSTATOGRAPHIC MACHINE

(71) Applicants: Andrew Peter Kittleson, Rochester, NY (US); M. Cristina B. Dejesus, Basking Ridge, NJ (US); Thomas Nathaniel Tombs, Rochester, NY (US); Charles Eugene Hewitt, Rochester, NY (US)

(72) Inventors: Andrew Peter Kittleson, Rochester, NY (US); M. Cristina B. Dejesus, Basking Ridge, NJ (US); Thomas Nathaniel Tombs, Rochester, NY (US); Charles Eugene Hewitt, Rochester, NY (US)

(21) Appl. No.: 13/193,907

(22) Filed: Jul. 29, 2011

(51) Int. Cl. B05C 1/08; G03G 15/01

(52) U.S. Cl. 492/18; 399/302

(57) ABSTRACT

The present invention is a sleeved roller for use in an electrostatographic machine. The roller includes a cylindrical rigid core member having an outer ceramer surface. A removable sleeve member includes a substrate comprising a polymeric material support layer, wherein the sleeve member surrounds and intimately contacts the outer ceramer surface. The invention provides a low cost sleeved roller, while providing a high friction interference fit to reduce slipping of the sleeve member during operation and thereby providing improved registration performance.

### CROSS-REFERENCE TO RELATED APPLICATIONS

Reference is made to commonly assigned U.S. Ser. No. ______ (Kodak Docket K000512) filed concurrently herewith, directed towards “Double Sleeved Roller for use in an Electrostatographic Machine,” the disclosure of which is incorporated by reference herein in its entirety.

### FIELD OF THE INVENTION

The present invention relates to field of printing and copying. More particularly, it relates to improvements in the structure of printing or image-transfer drums of the type having an outer sleeve that is supported by an underlying mandrel. Such drums are used, for example, in electrostatic document printers and copiers for temporarily receiving a toner image from an image-recording element before it is re-transferred to an image-receiver sheet or the like.

### BACKGROUND OF THE INVENTION

As described by Cormier et al, in U.S. Pat. No. 6,394,943, in printing machines, copiers and the like, images are often formed on or transferred to a drum having a flexible or resilient outer sleeve that, from time to time, requires replacement. Typically, the sleeve is operatively supported by a cylindrical rigid core member such as a metal cylinder or mandrel. In loading the sleeve onto the mandrel, it is common to inject air under the sleeve, thereby slightly expanding the sleeve diameter, while sliding the sleeve axially onto the mandrel's supporting surface. Usually, the nominal diameter of the outer sleeve is slightly less than the mandrel diameter. Thus, upon discontinuing the airflow, the sleeve contracts onto the mandrel and forms a tight, interference fit. The sleeve typically desirably includes a compliant cushion layer.

There are significant costs associated with compliant sleeve design. In order to meet registration requirements high precision grinding operations are typically employed to establish low run-out and surface roughness properties. The substrate for the sleeve member is typically a seamless metal, which adds significant cost to manufacture the sleeve. Additionally, in order to meet transfer and registration requirements, the sleeve must have a uniform diameter within narrow tolerances in order to minimize variations in overdrive and nip width. The grinding operation typically used to obtain the correct diameter is a manufacturing step adding significant cost to manufacture the sleeve. Additionally, the surface of the sleeve wears out prior to the loss of integrity to the sleeve as a whole so that more material waste than necessary is produced.

Chowdry et al, U.S. Pat. No. 6,377,772, describe an improved solution to multi-layer rollers by describing a double-sleeved roller including a rigid cylindrical core member, a replaceable removable compliant inner sleeve member (ISM) in non-adhesive contact with and surrounding the core member, and a replaceable removable outer sleeve member (OSM) in non-adhesive contact with and surrounding the inner sleeve member. The invention enables the independent replacement of the inner and outer sleeves to reduce the costs of the components. Tan et al, US2005/0138809 A1, US2005/0143240 A1, and US2005/0143241 A1 describe a sleeve member without a metal core, resulting in a reduced cost of the part. The compliant sleeve member is mounted directly on a mandrel to form an image cylinder or a blanket cylinder for use in an electrophotographic process. With the unsupported sleeve solution it can be difficult to balance the need for ease of installation with the need for properly mated sleeves and cores to avoid slipping during operation.

Zaretsky et al, US2008/0038025 A1 and US2008/0035265 A1, describe low cost intermediate transfer members formed from an endless belt of a seamed insulating material and a smoothing compliant layer disposed on the endless belt. Cody et al, US2008/0038566 A1, describe intermediate transfer members similarly formed from a low cost seamed insulating support layer, having a conductive layer disposes on at least the outer side of the insulating support layer, with a conductive connection between the inner side of the insulating support layer and the conductive outer layer. Kittleson et al, US2008/0051275 A1 describe a simplified mounting method for a double sleeved roller by enabling a method of mounting both components of the double sleeved roller configuration simultaneously, wherein the outer sleeve member may comprise a low-cost, seamed plastic substrate with a compliant layer cast thereon, such as described in US2008/0038025 A1, US2008/0035265 A1, and US2008/0038566 A1.

### SUMMARY OF THE INVENTION

A need exists for a novel replaceable removable sleeved roller that employs a removable sleeve member comprising a substrate comprising a polymeric material support layer for low cost, while providing a high friction interference fit to reduce slipping of the sleeve member during operation and providing improved registration performance.

The present invention provides a sleeved roller for use in an electrostatographic machine. The roller includes a cylindrical rigid core member having an outer ceramer surface. A removable sleeve member includes a substrate comprising a polymeric material support layer, wherein the sleeve member surrounds and intimately contacts the outer ceramer surface.

### BRIEF DESCRIPTION OF THE DRAWINGS

FIG. 1 is a schematic diagram of a mandrel and a sleeve, with the sleeve being positioned for installation on the mandrel; and

FIG. 2 is a schematic diagram of a sleeve positioned on the mandrel.

For better understanding of the present invention, together with other advantages and capabilities thereof, reference is made to the following detailed description in connection with the above-described drawings.

### DETAILED DESCRIPTION OF THE INVENTION

The invention discloses a sleeved roller for use in an electrostatographic machine, the sleeved roller including a substantially cylindrical substantially rigid core member, a replaceable removable sleeve member that may be single or multi-layer, in the shape of an endless tubular belt that can include at least one compliant layer such that the sleeve member surrounds and non-adhesively intimately contacts the core member. The core member has an outer surface of ceramer. The sleeve member comprises a substrate (onto which any further layers of the sleeve member are formed) comprising a polymeric material support layer.

The substrate of the sleeve member acts as a supporting element for any subsequent provided functional layers. The polymeric material support layer of the substrate may be of any of a variety of polymeric materials such as a fluorinated copolymer (such as polyvinylidene fluoride), polycarbonate, polyurethane, polyethylene terephthalate, polyimides (such as KAPTON), polyethylene napthalate, or silicone rubber. The substrate material may contain an additive, such as an anti-stat (e.g. metal salts), conductive polymers (e.g. polyaniline or polythiophene), conductive metal oxides (e.g. tin oxide) or small conductive particles (e.g. carbon), to impart the desired conductivity. The preferred support layer is a polymeric material such as polyester, polycarbonate, or polyamide but the specifics of the substrate will vary depending on the application. Preferably, the substrate is conductive or semi-conductive either along its surface and/or through its bulk. When employing a insulating polymer material support layer, the substrate may further comprise a surface conductive layer, including but are not limited to, e.g., vapor deposited aluminum, nickel, or indium tin oxide, or solution coated polythiophene, tin oxide, carbon black, carbon nanotubes, or polyaniline. While a surface conductive metal layer may be deposited on the polymeric material support layer of the substrate, such layer is relatively thin (e.g., less than 1 micrometers) compared to the polymeric material support layer itself, and it is the polymeric material support layer which mainly provides the mechanical strength of the substrate.

Fibrous material may be used to reinforce the polymeric material support layer. A reinforcing member of fibrous material can be prepared by weaving fibrous material into a mat or sheet as practiced in the art or the fibrous material may be held together in non-woven form with or without a bonding agent as practiced in the art.

The optimum thickness of the substrate will depend on the specific application and can typically range between 10 and 400 micrometers, with a preferred thickness between 50 and 200 micrometers.

In a particular embodiment, the polymeric material support layer forms an inner surface of the sleeve member which intimately contacts the outer ceramer surface of the cylindrical rigid core member. In a particularly preferred embodiment, the polymeric material support layer is a polyethylene terephthalate layer which forms an inner surface of the sleeve member which intimately contacts the outer ceramer surface of the cylindrical rigid core member.

The polymeric material support layer may be seamless (e.g., prepared by extrusion into an endless loop), but for reduced cost reasons is preferably in the form of a seamed flexible polymeric material film, and in particular in the form of a seamed polyethylene terephthalate film. Further details as to formation of sleeve members comprising a seamed polymeric film substrate are described in US2008/0038025 A1, US2008/0035265 A1, and US2008/0038566 A1, the disclosures of which are incorporated herein in their entireties.

The polymeric material support layer is preferable a flexible film layer, enabling low cost manufacture of the sleeve member substrate. The polymeric material support layer preferably has a Young's modulus greater than about 0.1 GPa and more preferably in a range of from 1-20 GPa. The modulus and thickness of the sleeve member layers both contribute to the hoop stiffness of each member. The hoop stiffness is characterized by the resistance of the member to expand diametrically such that greater hoop stiffness provides more resistance to diametric expansion.

Over the substrate, the sleeve member can include various further layers, for example, a plastic, a polymer, a copolymer, an elastomer, a foam, a photoconductive material, a material including filler particles, a material including two or more phases, or a material reinforced with fibers or mesh.

In particular embodiments, the substrate of the sleeve member is coated with a compliant layer having a thickness in a range 0.05-20 mm, more preferably 3-20 mm, and more preferably 5-15 mm, and has a Young's modulus less than about 50 MPa, preferably less than about 10 MPa and more preferably in a range 1-5 MPa. The compliant layer is preferably formed of a polymeric material, e.g., an elastomer such as silicone, a polyurethane or other materials well noted in the published literature, and may comprise a material having one or more phases, e.g., a foam or a dispersion of one solid phase in another. Preferably, the compliant layer has a Poisson's ratio in a range 0.2-0.5, and more preferably a Poisson's ratio in a range 0.45-0.5, and a preferred material is a polyurethane with a Poisson's ratio of about 0.495. In order to provide a suitable resistivity, the compliant layer may be doped with sufficient conductive material (such as antistatic particles, ionic or electronic conducting materials, or electrically conducting dopants) to have a moderate resistivity. The compliant layer should have a bulk electrical resistivity preferably in a range 10⁷-11 ohm-cm, and more preferably about 10⁹ ohm-cm.

The sleeve member preferably further includes an outer release layer, e.g. including a synthetic material such as a sol-gel, a ceramer, a polyurethane or a fluoropolymer, but other materials having good release properties including low surface energy materials may also be used. The release layer preferably has a Young's modulus greater than 100 MPa, more preferably 0.5-20 GPa, and a thickness preferably in a range of 1-50 micrometers and more preferably in a range 4-15 micrometers. The release layer preferably has a bulk electrical resistivity in a range 10⁷-10¹³ ohm-cm and more preferably about 10¹⁰ ohm-cm.

The sleeve comprising a polymeric material support layer is positioned on a cylindrical rigid core member having an outer ceramer surface. To provide an interference fit, the freestanding (unexpanded) inner diameter of the sleeve is smaller than the outer diameter of the core member prior to installation, and the sleeve is expanded when mounted on the core member, such as by employing an air bearing as described above. This is accomplished because the coefficient of friction is low between the sleeve and core member at low pressures or low velocities. When the electrostatographic machine is operating the pressure between the sleeve and core member increases drastically, and the sleeve does not slip on the core.

The use of a core member having an outer ceramer surface with a sleeve member having a substrate comprising a polymeric material support layer in accordance with the invention advantageously provides higher friction between the core member and the sleeve after installation of the sleeve, as the examples below demonstrate that substrates comprising a polymeric material support layer have significantly higher friction coefficients when paired with a mandrel having a ceramer surface than with a mandrel having a bare metal surface, and the friction coefficients generally increase at a greater rate with increasing force between the ceramer coated mandrel and the polymeric material support layer. Higher friction at lower pressure advantageously enables less of an interference fit be required to provide the needed grip between the sleeve and core member to prevent slip between such members. This is particularly useful when employing a sleeve member having a substrate comprising a polymeric material support layer in comparison to sleeve members having metal substrates, and especially when employing a seamed flexible polymeric material film for the sleeve substrate, as polymeric film substrates are generally less robust than metal layer substrates, and as seamed substrates may tear at the seam if stretched too much during the mounting process, or thereafter during operation of the electrostatographic machine.

The cylindrical rigid core member may comprise, e.g., a metal, preferably aluminum, mandrel provided with a ceramer outer coated surface layer. Such embodiment is preferred where a new mandrel is to be incorporated into an electrostatographic machine. Alternatively, existing metal mandrels may be retro-fitted with an inner sleeve member comprising a substrate coated with the ceramer layer, and the sleeve comprising a polymeric material support layer may be provided as an outer sleeve member over such inner sleeve member, wherein the outer sleeve member surrounds and intimately contacts the outer ceramer surface of the inner sleeve member and is removable. The inner sleeve member substrate may itself comprise a rigid metal cylinder, such as a nickel cylinder. In such embodiment, the inner sleeve member and mandrel together form the rigid core member having an outer ceramer surface employed in the present invention.

The term “ceramer” is formed by merging the words “ceramic” and “polymer.” Ceramers have been accepted by Chemical Abstracts Service (CAS) for monomer-based polymer registration (June 1994, Vol. 121). Ceramers are described in CAS Change in Indexing Policy for Siloxanes (January 1995) as “hybrid organic-inorganic networks prepared by hydrolytic polymerization (sol-gel process) of tetraalkoxysilanes with alkoxysilane-containing organic moieties, which may be trialkoxysilyl-terminated organic polymers.” In the present invention, this description is applicable to the ceramers comprising the outer layer of the core member, wherein the alkoxysilane comprises an alkoxysilyl-terminated polyurethane.

In accordance with the present invention, the sleeved roller member for electrostatography comprises a core or sleeve having outer surface layer comprising a ceramer that is preferably a polyurethane silicate hybrid organic-inorganic network. The ceramer of the outer surface layer preferably comprises the reaction product of a polyurethane having terminal reactive alkoxysilane moieties with a tetrasiloxysilane compound, such as described in U.S. Pat. No. 5,968,656, the disclosure of which is incorporated by reference in its entirety herein. In a more preferred embodiment, the polyurethane with terminal alkoxysilane groups is the reaction product of one or more aliphatic polyols having terminal hydroxyl groups and an alkoxysilane-substituted alkyl isocyanate compound. Suitable aliphatic polyols have molecular weights of about 60 to 8000 and may be polymeric. Polymeric aliphatic polyols may further include a plurality of functional moieties selected from the group consisting of an ester, an ether, a urethane, a non-terminal hydroxyl, and combinations thereof. Polymeric polyols containing ether functions are preferably polytetramethylene glycols having number-average molecular weights from about 200 to 6500, which can be obtained from various commercial source. For example, TERATHANE-2900, -2000, -1000, and -650 polytetramethylene glycols having the indicated number-average molecular weights are available from DuPont.

Polymeric polyols containing a plurality of urethane and ether groups are obtained by reaction of polyethylene glycols with alkylene diisocyanate compounds containing about 4 to 16 aliphatic carbon atoms, for example, 1,4-diisocyanatobutane, 1,6-diisocyanatohexane, 1,12-diisocyanatododecane, and, preferably, isophorone diisocyanate(5-isocyanato-1-(isocyanatomethyl)-1,3,3-trimethylcyclohexane). The reaction mixture may further include monomeric diols and triols containing 3 to about 16 carbon atoms; the triol compounds provide non-terminal hydroxyl substituents that provide crosslinking of the polyurethane. In a preferred embodiment of the invention, a polymeric polyol is formed from a mixture of isophorone diisocyanate, a polytetramethylene glycol having a number-average molecular weight of about 2900, 1,4-butanediol, and trimethylolpropane in a molar ratio of about 8:3:5:1.

Reaction of the aliphatic, preferably polymeric, polyol having terminal hydroxyl groups with an alkoxysilane-substituted alkyl isocyanate compound, which may be promoted by a condensation catalyst, for example, an organotin compound such as dibutyltin dilaurate, provides a polyurethane having terminal reactive alkoxysilane moieties, which undergoes further reaction, preferably acid-catalyzed, with a tetraalkoxysilane compound to provide a ceramer useful for the surface layer of the core of the present invention. The molar ratio of aliphatic polyol:alkoxysilane-substituted alkyl isocyanate is preferably about 4:1 to about 1:4, more preferably about 2:1 to about 1:2.

The aliphatic hydroxyl-terminated polyols employed in the preparation of the ceramer of the invention are of the general formula

HO—R¹—OH

and have molecular weights of about 60 to 8000. As previously noted, at least one polyol is preferably polymeric, and R¹ may include a plurality of ester, ether, urethane, and non-terminal hydroxyl groups.

The alkoxysilane-substituted alkyl isocyanate compound preferably has the formula

OCN—R²—Si(OR³)Z¹Z²

where R² is an alkylene group containing about 2 to 8 carbon atoms, OR³ is an alkoxy group containing 1 to about 6 carbon atoms, and Z¹ and Z² are moieties independently selected from the group consisting of alkoxy containing 1 to about 6 carbon atoms, hydrogen, halo, and hydroxy. More preferably, R² contains 2 to about 4 carbon atoms, and OR³, Z¹, and Z² are each alkoxy groups containing 1 to about 4 carbon atoms. An especially preferred alkoxysilane-substituted alkyl isocyanate compound is 3-isocyanatopropyl-triethoxysilane.

The tetraalkoxysilane compound is preferably selected from the group consisting of tetrabutyl orthosilicate, tetrapropyl orthosilicate, and, more preferably, tetraethyl orthosilicate.

The hybrid organic-inorganic network of the ceramer comprising the outer surface layer of the core of the invention may have the general structure as illustrated in col. 5 of U.S. Pat. No. 5,968,656, the disclosure of which is incorporated herein by reference in its entirety, where R¹ and R² are as previously defined. The hybrid organic-inorganic network includes about 10 to 80 weight percent, more preferably about 25 to 65 weight percent, and most preferably about 25 to 50 weight percent silicon oxide. The outer surface layer typically has a thickness of about 1μ to 20μ, preferably about 2μ to 12μ.

In a further embodiment of the invention, the ceramer may more specifically contain the reaction product of a polyurethane and tetraethoxyorthosilicate, where the polyurethane has a molecular weight from about 20,000 to about 80,000 and with the polyurethane and the tetraethoxyorthosilicate being employed in a weight ratio from about 1.8 to about 2.3, as described in U.S. Pat. No. 7,351,512, the disclosure of which is incorporated by reference herein in its entirety.

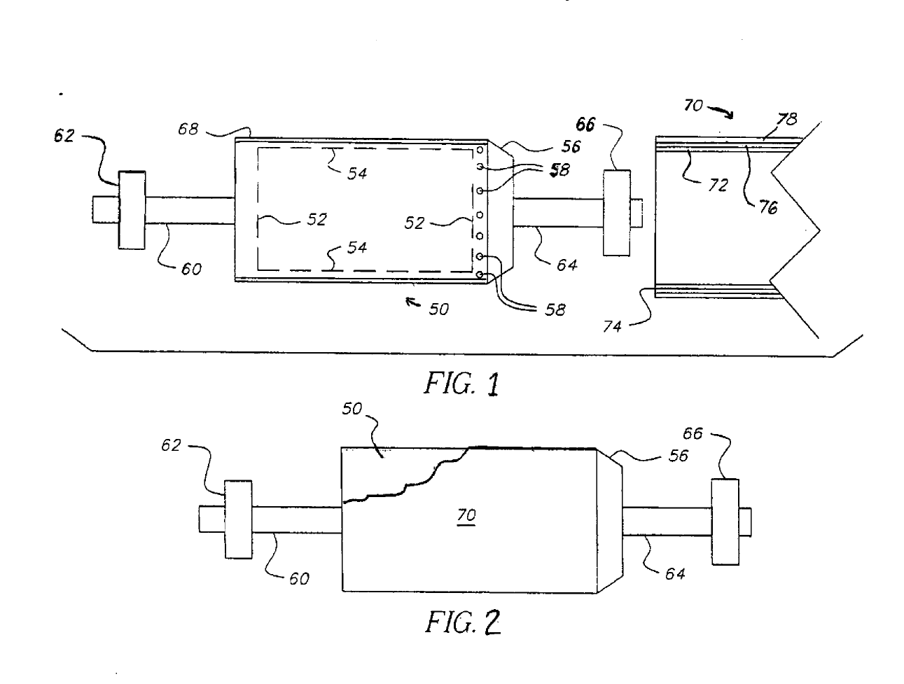

FIG. 1 shows a blanket cylinder in accordance with an embodiment of the invention including a mandrel 50 that has side walls 54 and ends 52, and has a tube 60 which supports a bearing 62 in operative engagement with one end of mandrel 50 and a shaft 64 which supports a second bearing 66 in operative engagement with the other end of mandrel 50. Side walls 54 have an outer ceramer surface 68. Tube 60 is adapted for injection of air into mandrel 50, which includes near one of its ends, a taper 56, and a plurality of air holes 58. These air holes are used for the ejection of air during the installation of a sleeve 70 over mandrel 50. Mandrel 50 has an outside diameter of surface 68 which is somewhat larger than the diameter of the inner surface of sleeve 70. Sleeve 70 as shown comprises a polymeric material support layer 72, a cushion layer 76, and a outer release layer 78. Its end 74 is urged into engagement with tapered section 56 of mandrel 50 and the sleeve is placed over outer surface 68 of mandrel 50 by an air step process using the ejection of air through holes 58. FIG. 2 shows an installed sleeve 70 on mandrel 50.

### EXAMPLES

Three cylindrical rigid core members were employed in the following examples:

Core A: An aluminum surface cylindrical mandrel having 154.000 mm outer diameter, supplied by NEXPRESS.

Core B: A nickel surface cylindrical mandrel comprising Core A mounted with a 0.125 mm thick Ni sleeve.

Core C: A ceramer surface cylindrical mandrel comprising Core A mounted with a ceramer coated 0.125 mm thick Ni sleeve. The ceramer coating comprised a polyurethane silicate hybrid organic-inorganic network resulting from the reaction product of a polyurethane having terminal reactive ethoxysilane groups with a tetraethoxysilane compound, similarly as prepared in Example 1 of U.S. Pat. No. 5,968,656, but with approximately 30 wt % SiO2 content. The ceramer formulation was ring-coated on the Ni sleeve, dried and cured similarly as employed in Example 13 of U.S. Pat. No. 5,968,656, to form an approximately 6 micrometer thick ceramer coating.

Coefficients of Friction (COF) between test strips of various flexible web materials and each of core member mandrels Core A to Core C were calculated according to ASTM Standard Test Method G 143-96, employing a test apparatus including a force measuring device attached to one end of the web material used as one member of the friction couple, the mandrel as the stationary cylindrical surface used as the other member of the friction couple, a system to move the flexible web member of the friction couple, and masses used to tension the free end of the test strip, according to the equation:

μ=ln(T2/T1)/a

where:
a represents the angle or wrap on the cylindrical surface, radian (rad), that is a=b/57.296, where b is the angle of wrap;
T1 represents the force applied to the free end of the web by the hanging mass (the lower of the two tensions), N, and

T2 represents the force recorded by the friction force transducer during the test (the higher of the two tensions), N.

The test method used employed a wrap angle of 90 degrees, and the friction force transducer force measuring device employed had a highest measurement capacity of 230 N.

All test strips were cut to 25 mm wide and 500 mm long (long enough to wrap the mandrel 90 degrees and provide ample distance to attach the weight and transducer while providing a travel distance of 100 mm).
Ni strips were 0.125 mm thick
Al Coated PET strips were 0.125 mm thick PET with vapor deposited aluminum (approximately 250-300 angstrom Al coating)
Ni Coated PET strips were 0.125 mm thick PET with vapor deposited nickel (approximately 100-150 angstrom Ni coating)
Bare PET strips were 0.100 mm thick
Polyimide strips were 0.080 mm thick
Urethane coated PET strips were 0.100 mm thick PET coated with 0.5 micrometer polyurethane coating.
   Results from the Core A Al mandrel test cases are reported in Table 1 below:

TABLE 1
Core A Mandrel with Aluminum surface

| | | | | | | |
|---|---|---|---|---|---|---|
| Ni (bare metal strip) | T1 (N) | 0.3 | 1.5 | 5.5 | 18.7 | 73.0 |
| | T2 (N) | 0.8 | 2.4 | 8.1 | n/a | 112.5 |
| | COF | 0.57 | 0.28 | 0.25 | n/a | 0.28 |
| Al-coated PET | T1 (N) | 0.3 | 1.5 | 5.5 | 18.7 | 73.0 |
| | T2 (N) | 1.1 | 2.4 | 8.0 | 29.5 | n/a |
| | COF | 0.74 | 0.28 | 0.24 | 0.29 | n/a |
| Ni-coated PET | T1 (N) | 0.3 | 1.5 | 5.5 | 18.7 | 73.0 |
| | T2 (N) | 1.2 | 2.4 | 7.7 | 26.9 | n/a |
| | COF | 0.77 | 0.28 | 0.22 | 0.23 | n/a |
| PET (bare) | T1 (N) | 0.3 | 1.5 | 5.5 | 18.7 | 73.0 |
| | T2 (N) | 1.1 | 2.5 | 7.9 | 26.9 | n/a |
| | COF | 0.74 | 0.30 | 0.24 | 0.23 | n/a |
| Urethane-coated PET | T1 (N) | 0.3 | 1.5 | 5.5 | 18.7 | 73.0 |
| | T2 (N) | 0.6 | 2.4 | 7.2 | 24.5 | n/a |
| | COF | 0.39 | 0.28 | 0.18 | 0.17 | n/a |
| Polyimide | T1 (N) | 0.3 | 1.5 | 5.5 | 18.7 | 73.0 |
| | T2 (N) | 0.8 | 2.4 | 7.9 | 27.2 | n/a |
| | COF | 0.54 | 0.28 | 0.23 | 0.24 | n/a |

Results from the Core B Ni surface mandrel test cases are reported in Table 2 below:

TABLE 2
Core B Mandrel with Nickel surface

| | | | | | | |
|---|---|---|---|---|---|---|
| Al-coated PET | T1 (N) | 0.3 | 1.5 | 5.5 | 18.7 | 73.0 |
| | T2 (N) | 1.1 | 3.1 | 9.8 | 33.0 | n/a |
| | COF | 0.76 | 0.44 | 0.37 | 0.36 | n/a |
| Ni-coated PET | T1 (N) | 0.3 | 1.5 | 5.5 | 18.7 | 73.0 |
| | T2 (N) | 1.2 | 3.2 | 10.0 | 35.2 | n/a |
| | COF | 0.79 | 0.46 | 0.39 | 0.40 | n/a |
| PET (bare) | T1 (N) | 0.3 | 1.5 | 5.5 | 18.7 | 73.0 |
| | T2 (N) | 0.9 | 2.7 | 8.3 | 27.6 | n/a |
| | COF | 0.64 | 0.37 | 0.26 | 0.25 | n/a |
| Urethane-coated PET | T1 (N) | 0.3 | 1.5 | 5.5 | 18.7 | 73.0 |
| | T2 (N) | 0.8 | 2.5 | 8.2 | 28.3 | n/a |
| | COF | 0.52 | 0.32 | 0.26 | 0.26 | n/a |
| Polyimide | T1 (N) | 0.3 | 1.5 | 5.5 | 18.7 | 73.0 |
| | T2 (N) | 0.9 | 2.5 | 8.3 | 27.9 | n/a |
| | COF | 0.60 | 0.33 | 0.27 | 0.25 | n/a |

Results from the ceramer coated mandrel test cases are reported in Table 3 below:

TABLE 3
Core C Mandrel with Ceramer coated surface

| | | | | | | |
|---|---|---|---|---|---|---|
| Ni (bare | T1 (N) | 0.3 | 1.5 | 5.5 | 18.7 | 73.0 |
| metal strip) | T2 (N) | 9.2 | 19.8 | >230.0 | n/a | n/a |
| | COF | 2.09 | 1.63 | >2.38** | n/a | n/a |
| Al-coated | T1 (N) | 0.3 | 1.5 | 5.5 | 18.7 | 73.0 |
| PET | T2 (N) | 1.7 | 4.8 | 16.4 | 79.9 | n/a |
| | COF | 1.00 | 0.73 | 0.70 | 0.92 | n/a |
| Ni-coated | T1 (N) | 0.3 | 1.5 | 5.5 | 18.7 | 73.0 |
| PET | T2 (N) | 1.8 | 40.2 | 147.9 | >230.0 | n/a |
| | COF | 1.05 | 2.08 | 2.10 | >1.6** | n/a |
| PET (bare) | T1 (N) | 0.3 | 1.5 | 5.5 | 18.7 | 73.0 |
| | T2 (N) | >230.0 | >230.0 | >230.0 | >230.0 | n/a |
| | COF | >4.14** | * | * | * | n/a |
| Urethane- | T1 (N) | 0.3 | 1.5 | 5.5 | 18.7 | 73.0 |
| coated PET | T2 (N) | 1.8 | 3.9 | 21.8 | 72.3 | n/a |
| | COF | 1.05 | 0.59 | 0.88 | 0.86 | n/a |
| Polyimide | T1 (N) | 0.3 | 1.5 | 5.5 | 18.7 | 73.0 |
| | T2 (N) | 1.1 | 5.3 | 35.2 | >230.0 | n/a |
| | COF | 0.72 | 0.80 | 1.19 | >1.6** | n/a |

* Not calculated, as highest T2 measurement capacity of 230 N was exceeded at lower T1 force.
**Based on calculation for T2 = 230 N.

The above results demonstrate that substrates comprising a polymeric material support layer have significantly higher friction coefficients when paired with the mandrel having a ceramer surface than with a mandrel having a bare metal surface. Further, the friction coefficients generally increase at a greater rate with increasing force T1 for the ceramer coated mandrel. The results are particularly evident with the bare PET test strip, which demonstrated a significantly higher COF than the other materials, as the maximum measurable force T2 was observed at the minimum force T1 tested.

Preparation of Blanket Cylinder Sleeve with PET Polymeric Material Support Layer and Polyurethane Cushion Layer

A 0.175 mm thick PET substrate of 482 mm length was rolled into a cylinder with 0.750 mm of overlap and ultrasonically welded, resulting in a seamed PET cylinder having a 153.187 mm diameter. The PET cylinder was coated with a polyurethane cushion layer of composition similar to that of Example 12 of U.S. Pat. No. 5,968,656, which was cured and then ground to a 174.000 mm outer diameter. An approximately 6 micrometer thick ceramer release layer comprised of a polyurethane silicate hybrid organic-inorganic network was ring-coated, dried and cured on the polyurethane cushion layer similarly as in Example 13 of U.S. Pat. No. 5,968,656, with approximately 30 wt % SiO2 content.

Testing of Blanket Cylinder Sleeve with PET Polymeric Material Support Layer and Polyurethane Cushion Layer on Mandrels

The blanket cylinder sleeve with PET substrate was then installed over each of cylindrical rigid core members Core A (aluminum mandrel with aluminum surface), Core B (aluminum mandrel with bare nickel sleeve) and Core C (aluminum mandrel with ceramer coated nickel sleeve) as described above. Installation and removal of the blanket sleeve was accomplished easily employing conventional air-bearing techniques. Sleeve to mandrel creep (slip), however, was observed upon testing of the sleeved rollers employing each of the bare metal Core A and Core B mandrels in an electrophotographic apparatus with a counter-rotating roller forming a pressure nip with nip widths of 5.5 mm and 8.00 mm, while no creep (slip) was observed for the sleeved roller employing the Core C mandrel provided with a ceramer outer surface in accordance with the present invention for an even more demanding nip width of 8.5 mm after 24 hours of rolling.

The invention has been described with reference to a preferred embodiment; however, it will be appreciated that variations and modifications can be effected by a person of ordinary skill in the art without departing from the scope of the invention.

1. A sleeved roller for use in an electrostatographic machine, comprising:
a cylindrical rigid core member comprising an outer ceramer surface; and
a removable sleeve member, comprising a substrate comprising a polymeric material support layer, wherein the sleeve member surrounds and intimately contacts the outer ceramer surface and is removable.

2. The sleeved roller according to claim 1 wherein the polymeric material support layer is a polyethylene terephthalate layer.

3. The sleeved roller according to claim 2, wherein the polyethylene terephthalate layer forms an inner surface of the sleeve member which intimately contacts the outer ceramer surface of the cylindrical rigid core member.

4. The sleeved roller according to claim 3 wherein the polymeric material support layer of the sleeve member has a Young's modulus greater than about 0.1 GPa.

5. The sleeved roller of claim 4 wherein the ceramer comprises a polyurethane silicate hybrid organic-inorganic network.

6. The sleeved roller according to claim 5 wherein the ceramer comprises the reaction product of a polyurethane having terminal reactive alkoxysilane groups with a tetraalkoxysilane compound.

7. The sleeved roller according to claim 5, wherein the sleeve further comprises a cushion layer having a thickness of 0.05 to 20 mm and a Young's modulus of less than 10 MPa.

8. The sleeved roller according to claim 7 wherein the sleeve further comprises a release layer on an outer surface.

9. The sleeved roller according to claim 8 wherein the release layer comprises a ceramer.

10. The sleeved roller according to claim 1, wherein the polymeric material support layer forms an inner surface of the sleeve member which intimately contacts the outer ceramer surface of the cylindrical rigid core member.

11. The sleeved roller according to claim 1 wherein the polymeric material support layer of the sleeve member has a Young's modulus greater than about 0.1 GPa.

12. The sleeved roller of claim 1 wherein the ceramer comprises a polyurethane silicate hybrid organic-inorganic network.

13. The sleeved roller according to claim 12 wherein the ceramer comprises the reaction product of a polyurethane having terminal reactive alkoxysilane groups with a tetraalkoxysilane compound.

14. The sleeved roller according to claim 1, wherein the sleeve further comprises a cushion layer having a thickness of 0.05 to 20 mm and a Young's modulus of less than 10 MPa.

15. The sleeved roller according to claim 1 wherein the sleeve further comprises a release layer on an outer surface.

16. The sleeved roller according to claim 15 wherein the release layer comprises a ceramer.

17. The sleeved roller according to claim 1 wherein the polymeric material support layer is a seamed polymeric material film.

18. The sleeved roller according to claim 17, wherein the polymeric material support layer is a seamed polyethylene terephthalate film.
